(19) United States
(12) Patent Application Publication
(10) Pub. No.: US 2005/0136910 A1
(43) Pub. Date: Jun. 23, 2005

(54) Multicast SDMA training polls

(76) Inventors: Qinghua Li, Sunnyvale, CA (US); Minnie Ho, Los Altos, CA (US); Adrian P. Stephens, Cambridge (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/740,648

(22) Filed: Dec. 18, 2003

(51) Int. Cl. H04Q 7/20

(52) U.S. Cl. 455/423; 455/422.1

(57) ABSTRACT

When initiating SDMA training sequences, a base station may poll multiple mobile devices with the same multicast training poll, and the polled mobile stations may respond separately at different times based on an assigned delay period for each mobile station.

### BACKGROUND

To address the problem of ever-increasing bandwidth requirements that are placed on wireless data communications systems, various techniques are being developed to allow multiple devices to communicate with a single base station by sharing a single channel. In one such technique, a base station may transmit or receive separate signals to or from multiple mobile devices at the same time on the same frequency, provided the mobile devices are located in sufficiently different directions from the base station. For transmission from the base station, different signals may be simultaneously transmitted from each of separate spaced-apart antennas so that the combined transmissions are directional, i.e., the signal intended for each mobile device may be relatively strong in the direction of that mobile device and relatively weak in other directions. In a similar manner, the base station may receive the combined signals from multiple independent mobile devices at the same time on the same frequency through each of separate spaced-apart antennas, and separate the combined received signals from the multiple antennas into the separate signals from each mobile device through appropriate signal processing so that the reception is directional.

Under currently developing specifications, such as IEEE 802.11 (IEEE is the acronym for the Institute of Electrical and Electronic Engineers, 3 Park Avenue, 17th floor, New York, N.Y.), the parameters needed to control the directional nature of both transmissions and receptions may vary depending on various factors, including the direction of each mobile device from the base station. Since these factors may not be known in advance of operation, and may even change during operation, they may not be programmed into the system in advance. To develop such parameters during operation, a training phase may be performed in which a designated mobile device is polled to send a transmission with known characteristics to the base station at a designated time. The base station receives and processes the training transmission to derive the required parameters. Each mobile device may be separately polled and respond in a similar manner until the base station has performed a separate training phase with every mobile device. However, the overhead involved in setting up a separate training session with each of multiple mobile devices may occupy a significant amount of time and cause inefficiencies in the overall throughput of the network.

### BRIEF DESCRIPTION OF THE DRAWINGS

The invention may be understood by referring to the following description and accompanying drawings that are used to illustrate embodiments of the invention. In the drawings:

FIG. 1 shows a diagram of a communications network, according to an embodiment of the invention.

FIG. 2 shows a timing diagram of a training phase with multiple mobile devices, according to an embodiment of the invention.

FIG. 3 shows a flow chart of a method of operation of a base station, according to an embodiment of the invention.

FIG. 4 shows a flow chart of a method of operation of a mobile device, according to an embodiment of the invention.

FIG. 5 shows a block diagram of a base station, according to an embodiment of the invention.

FIG. 6 shows a block diagram of a mobile device, according to an embodiment of the invention.

### DETAILED DESCRIPTION OF THE INVENTION

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are either in direct physical or electrical contact, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing,” “computing,” “calculating,” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data from registers and/or memory to transform that electronic data into other electronic data that may be stored in registers and/or memory. A “computing platform” may comprise one or more processors.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

In keeping with common industry terminology, the terms “base station”, “access point”, and “AP” may be used interchangeably herein to describe an electronic device that may communicate wirelessly and substantially simultaneously with multiple other electronic devices, while the terms “mobile device” and “STA” may be used interchangeably to describe any of those multiple other electronic devices, which may have the capability to be moved and still communicate, though movement is not a requirement. However, the scope of the invention is not limited to devices that are labeled with those terms. Similarly, the terms “spatial division multiple access” and SDMA may be used interchangeably. As used herein, these terms are intended to encompass any communication technique in which different signals may be transmitted by different antennas substantially simultaneously from the same device such that the combined transmitted signals result in different signals intended for different devices being transmitted substantially in different directions on the same frequency, and/or techniques in which different signals may be received substantially simultaneously through multiple antennas on the same frequency from different devices in different directions and the different signals may be separated from each other through suitable processing. The term “same frequency”, as used herein, may include slight variations in the exact frequency due to such things as bandwidth tolerance, Doppler shift adaptations, parameter drift, etc. Two or more transmissions to different devices are considered substantially simultaneous if at least a portion of each transmission to the different devices occurs at the same time, but does not imply that the different transmissions must start and/or end at the same time, although they may. Similarly, two or more receptions from different devices are considered substantially simultaneous if at least a portion of each reception from the different devices occurs at the same time, but does not imply that the different transmissions must start and/or end at the same time, although they may. Variations of the words represented by the term SDMA may sometimes be used by others, such as but not limited to substituting “space” for “spatial”, or “diversity” for “division”. The scope of various embodiments of the invention is intended to encompass such differences in nomenclature.

Some embodiments of the invention may use a multicast signal to poll multiple mobile devices with a single transmission, with the mobile devices responding in a specific order at different times.

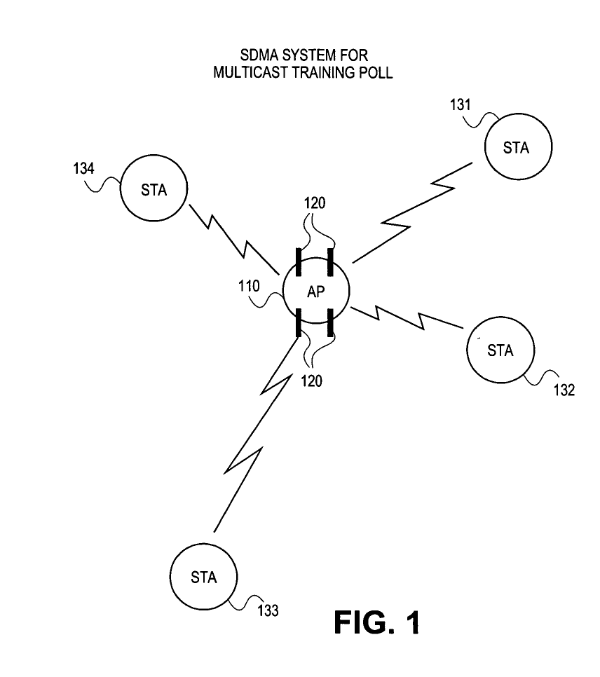

FIG. 1 shows a diagram of a communications network that may use multicast training polls, according to an embodiment of the invention. A poll may be a request for the addressed device(s) to respond by transmitting a signal and/or information back to the polling device, where the training poll may request that the signal and/or information be of a format suitable to determine one or more communications operating parameters. The illustrated embodiment of an SDMA-based network shows an AP 110 that may communicate with multiple STAs 131-134 located in different directions from the AP. Although AP 110 is shown with four antennas 120, other embodiments may have other arrangements (e.g., AP 110 may have two, three, or more than four antennas). Each STA may have at least one antenna to communicate wirelessly with the AP 110. In some embodiments the STA antenna(s) may be adapted to operate omnidirectionally, but in other embodiments the STA antenna(s) may be adapted to operate directionally. In some embodiments the STAs may be in fixed locations, but in other embodiments at least some of the STAs may be moving during and/or between communications sequences. In some embodiments the AP 110 may be in a fixed location, but in other embodiments the AP 110 may be moving during and/or between communications sequences.

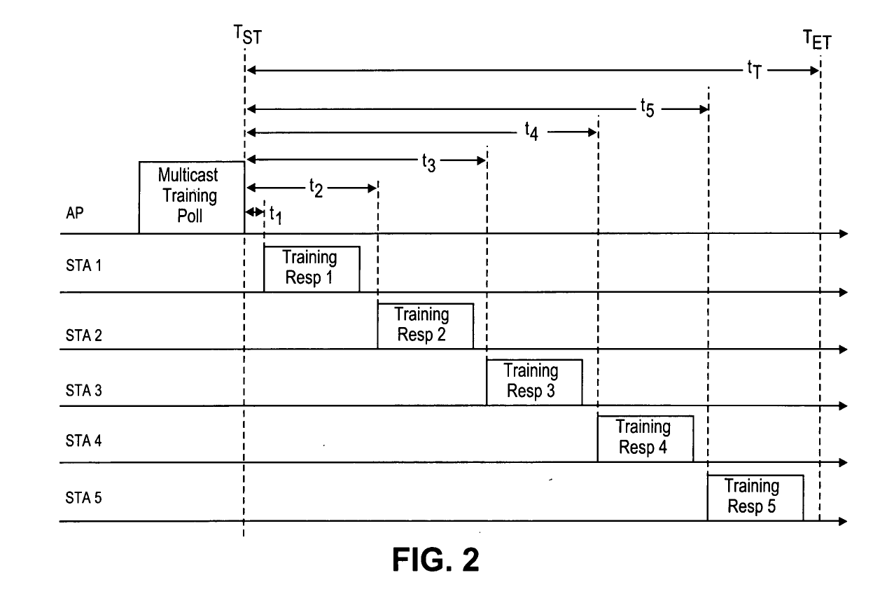

FIG. 2 shows a timing diagram of a communications sequence involving a multicast training poll, according to an embodiment of the invention. By way of example, the illustrated embodiment shows 5 STAs, labeled STA1 through STA5, but the scope of the invention is not limited to this quantity. To perform a training phase the AP may poll each STA in a training group (e.g., in the illustrated embodiment a training group consists of STA1-STA5), the poll requesting each of the selected STAs to send a training response back to the AP so that parameters for SDMA communication with that STA may be determined by the AP. Each training response may occur at a different time so that the training responses from multiple STAs do not interfere with each other. In the illustrated embodiment, all five of the relevant STAs are polled in a single transmission by using a multicast transmission for a training poll. A multicast transmission is addressed to multiple specific devices, each of which is expected to act upon the common content of the transmission. This is in contrast to the more common singly-addressed transmission (addressed to a single specific device), or a broadcast (which may be intended to be acted upon by any devices able to receive it). In some embodiments the multicast training poll may be sent omnidirectionally, so that all STAs within range may receive the training poll, but only those that are addressed should respond to it, although the invention is not limited in this respect. Along with its individual address, each addressed STA may also receive an individual timing indicator directing the STA to wait for a particular time duration before responding with a training response. In the illustrated embodiment of FIG. 2A, the individual timing durations are shown as t₁-t₅ for STA1-STA5, respectively. In some embodiments the timing indicator may be a simple ranking (e.g., 1, 2, 3, etc.) which the indicated STA may multiply by a time increment to determine how long to wait, but other embodiments may use other techniques (e.g., an indicator may be directly expressed in units of time; each STA may wait until the next higher-ranked STA has finished responding before transmitting, t₁ may always be a short fixed delay such as 0, etc.). The time t_{T} for the training responses is shown in FIG. 2A as the time between the training response start time (T_{ST}) and the training response end time (T_{ET}). After the training phase ends at time T_{ET}, the AP may initiate a data phase (not shown), using the parameters derived from the training phase.

In other embodiments the timing indicator for each STA may have been previously determined. For example, the time delay may have been delivered to each STA in a previous communication, although the scope of the invention is not limited to this or the other examples given.

The determination of which STAs to include in a multicast training poll may be determined by various factors. Each of the STAs may have previously established its presence with the AP, and may have provided information on its address, mode of wireless communication, possible data rates, etc. These and/or other factors may be considered by the AP in determining which STAs to place into the same multicast group. If the AP does not receive a satisfactory training response from a particular STA, that STA may be polled again (e.g., in another multicast training group). In some operations, a multicast training phase may be followed immediately by a data phase, but in other operations the training phase may be followed by another training phase with a different set of STAs, or by a different type of communication phase. A data phase may involve only the same STAs that were in the preceding training phase, or may involve a different group of STAs that includes some, none, or all of the STAs that were in the preceding training phase.

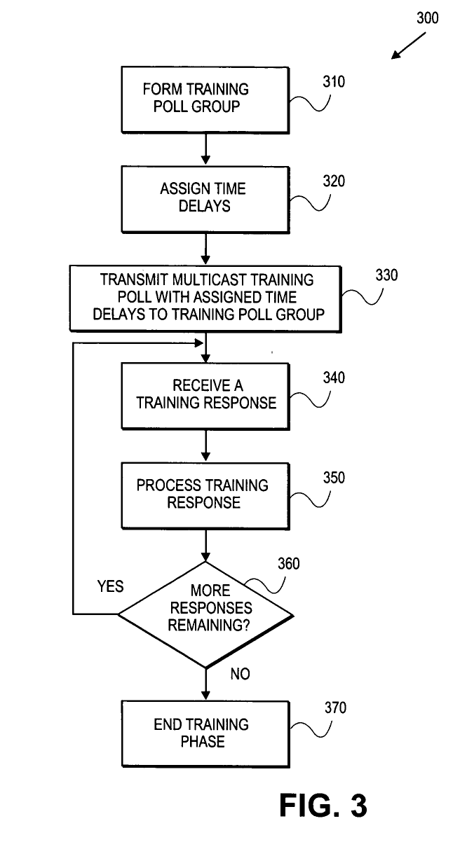

FIG. 3 shows a flow chart of a method of operation which may be performed by a base station, according to an embodiment of the invention. In flow chart 300, a training poll group may be formed at 310. Various criteria may be used to determine which of the currently available STAs are to be associated with the particular training poll group. For example, currently usable SDMA parameters may already be known for some of the STAs, and those STAs might be excluded from the poll group in favor of other STAs for which SDMA parameters do not yet exist or need to be updated.

After deciding which STAs to include in the group, at 320 the AP may assign a different time delay for each STA in the group. These time delays may be in any usable form, e.g., a direct time delay, a quantity of known increments of time, an ordinal ranking which can be multiplied by known increments of time, etc. In some embodiments, the time delays may be determined such that the minimum time between any two time delays is sufficient for a mobile device to transmit a training response, so that two different training responses from two different mobile devices do not overlap. At 330 a multicast training poll may be transmitted, containing the addresses of the STAs being polled, the time delays for the STAs being polled, and any other information deemed useful in the training poll.

After the poll has been transmitted and the response period has begun, the AP may receive the first training response at 340. At 350 the AP may process the received training response and store the processed information for further processing at a later time. The amount of processing performed at this point may vary (e.g., digitizing the signal and storing it for further processing, calculating SDMA parameters, etc.).

If further responses are expected, as indicated at 360, the AP may return to 340 to receive the next training response. The loop formed by 340, 350 and 360 may continue until all the STAs in the poll group have had time to respond, at which time the training phase may end. If any of the polled STAs do not respond, or if the received response is not useable for its intended purpose (e.g., due to corrupted data), that STA may be polled again at a later time, possibly in another poll group. A maximum number of retries for such polls may be established, although the scope of various embodiments of the invention is not limited in this respect.

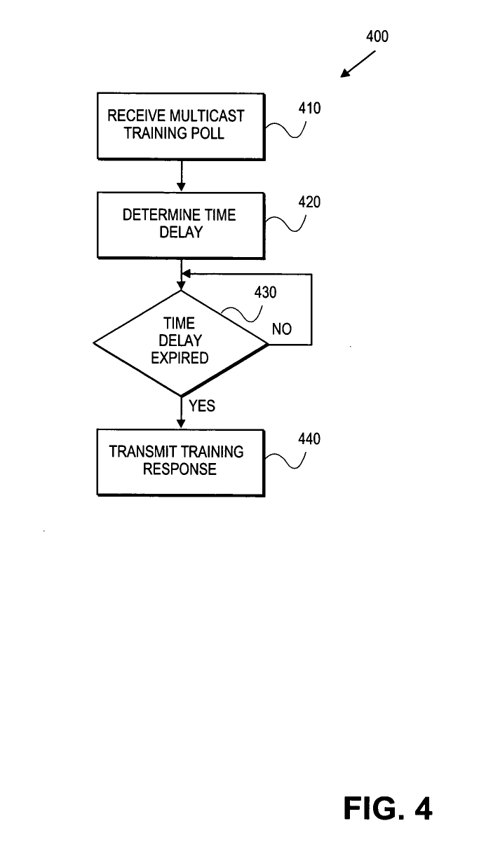

FIG. 4 shows a flow chart of a method of operation which may be performed by a mobile device, according to an embodiment of the invention. In flow chart 400, at 410 a multicast training poll may be received, containing the address or other identifier of this mobile device. At 420 the timing indicator associated with this mobile device may be extracted from the multicast poll and a time delay may be determined from the timing indicator. At 430 the mobile device may wait until the time delay determined at 420 has expired. The time delay may be measured from any feasible staring point, as previously described. Upon expiration of the time delay, the mobile device may transmit its own training response at 440.

Embodiments of the invention may be implemented in one or a combination of hardware, firmware, and software. Embodiments of the invention may also be implemented as instructions stored on a machine-readable medium, which may be read and executed by a processing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

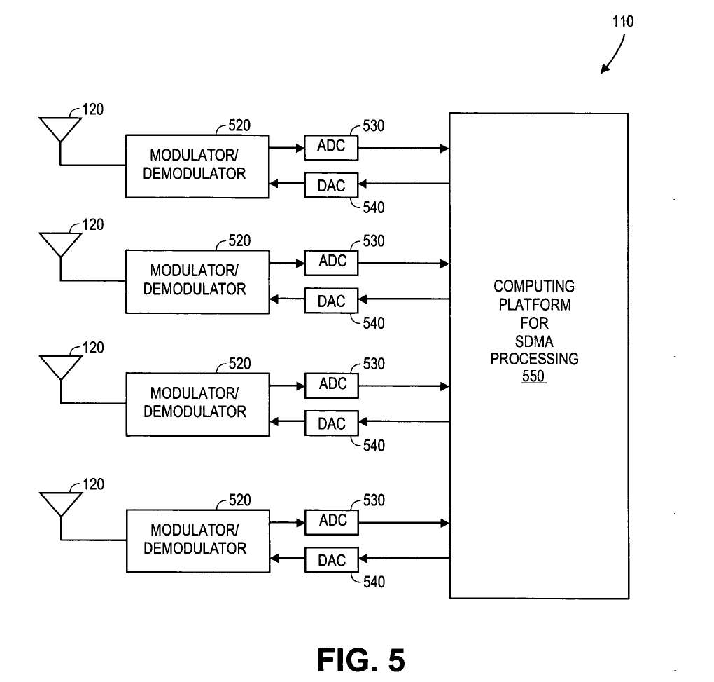

FIG. 5 shows a block diagram of a base station, according to an embodiment of the invention. Computing platform 550 may include one or more processors, and at least one of the one or more processors may be a digital signal processor (DSP). In the illustrated embodiment, AP 110 has four antennas 120, but other embodiments may have two, three, or more than four antennas. For each antenna, base station 110 may have a modulator/demodulator 520, an analog-to-digital converter (ADC) 530, and a digital-to-analog converter (DAC) 540. The combination of demodulator-ADC may convert received radio frequency signals from the antenna into digital signals suitable for processing by the computing platform 550. Similarly, the combination of DAC-modulator may convert digital signals from the computing platform 550 into radio frequency signals suitable for transmission through an antenna. Other components not shown may be included in the illustrated blocks as needed, such as but not limited to amplifiers, filters, oscillators, multiple DACs and/or ADCs where only one is shown, etc.

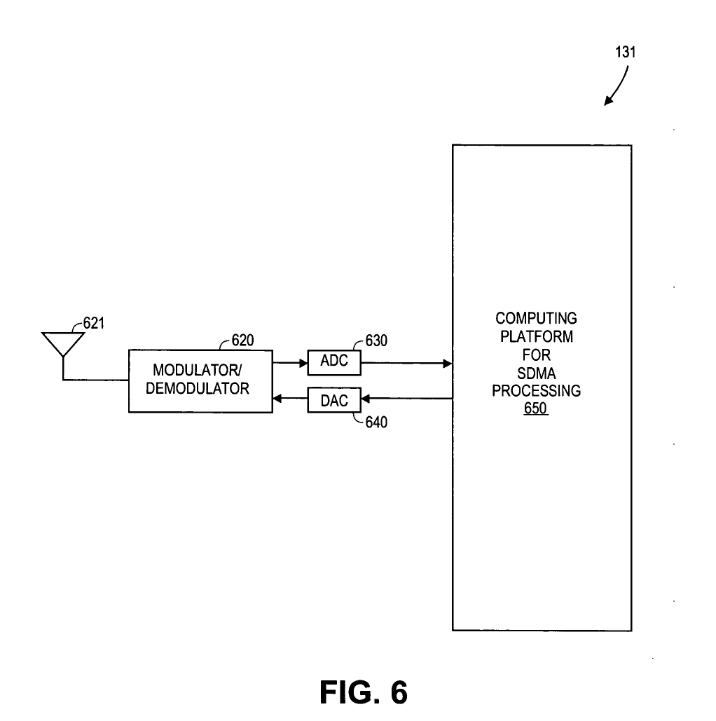

FIG. 6 shows a block diagram of a mobile device, according to an embodiment of the invention. The illustrated components of mobile device 131 may include a computing platform 650, antenna 621, modulator/demodulator 620, ADC 630, and DAC 640 that may be functionally similar to those similarly-named components of FIG. 5, but the device of FIG. 6 is shown with a single antenna/modulator/demodulator/ADC/DAC combination, and the computing platform 650 may perform the operations previously described for a mobile device rather than a base station, although various embodiments of the invention are not limited in these respects.

The foregoing description is intended to be illustrative and not limiting. Variations may occur to those of skill in the art. Those variations are intended to be included in the various embodiments of the invention, which are limited only by the spirit and scope of the appended claims.

1. An apparatus, comprising
a first electronic device adapted to wirelessly transmit a multicast poll containing
a first address of a second electronic device and a first time delay indicator indicating a time for the second electronic device to wait before transmitting a first training response; and
a second address of a third electronic device and a second time delay indicator indicating a time for the third electronic device to wait before transmitting a second training response.

2. The apparatus of claim 1, wherein the first and second training responses are usable for determining parameters for spatial division multiple access operations.

3. The apparatus of claim 1, wherein the first electronic device is further adapted to create a poll group by assigning the first and second addresses to the poll group.

4. The apparatus of claim 1, wherein a difference between a time delay indicated by the first time delay indicator and a time delay indicated by the second time delay indicator is at least as great as a time for the second electronic device to transmit the first training response.

5. The apparatus of claim 1, wherein the first electronic device is further adapted to the place the second address in another training poll responsive to not receiving the second training response before an end of a training phase.

6. The apparatus of claim 1, comprising:
a computing platform; and
at least four antennas coupled to the computing platform.

7. The apparatus of claim 6, further comprising:
at least four modulator/demodulators, each of the modulator/demodulators coupled between the computing platform and at least one of the antennas.

8. An apparatus comprising
an electronic device adapted to:
receive a poll with multiple addresses including a particular address associated with the electronic device; and
wirelessly transmit a response to the poll subsequent to an expiration of a timing delay associated with the particular address.

9. The apparatus of claim 8, wherein the response is a training response to be used to determine parameters for spatial division multiple access operations.

10. The apparatus of claim 8, wherein the poll includes a timing indicator indicative of the timing delay.

11. The apparatus of claim 10, wherein the electronic device is further adapted to determine the timing delay from the timing indicator.

12. The apparatus of claim 11, wherein the timing indicator is a ranking.

13. The apparatus of claim 10, wherein the timing indicator is an expression of units of time.

14. The apparatus of claim 8, comprising:
a computing platform; and
an antenna coupled to the computing platform.

15. The apparatus of claim 14, further comprising:
a modulator/demodulator coupled to the antenna;
an analog-to-digital converter coupled between the modulator/demodulator and the computing platform; and
a digital-to-analog converter coupled between the modulator/demodulator and the computing platform.

16. A method, comprising:
transmitting a multicast poll to multiple electronic devices; and
receiving a response from each of the multiple electronic devices, each of the responses being received at different times.

17. The method of claim 16, wherein said receiving comprises receiving training response from which to determine parameters for spatial division multiple access operation.

18. The method of claim 16, further comprising determining a poll group for the multicast poll prior to said transmitting, the poll group indicating identifying information on the multiple electronic devices.

19. The method of claim 16, further comprising transmitting a timing indicator to at least one of the multiple electronic devices, the timing indicator indicative of a time delay for the at least one of the multiple electronic devices to wait before transmitting one of the responses.

20. A method, comprising:
receiving a multicast poll containing a particular identifier; and
transmitting a response to the multicast poll after a particular time delay associated with the particular identifier.

21. The method of claim 20, wherein said transmitting comprises transmitting a response from which parameters for spatial division multiple access operation may be determined.

22. The method of claim 20, wherein said receiving comprises:
receiving a timing indicator; and
determining the particular time delay from the timing indicator.

23. A machine-readable medium that provides instructions, which when executed by a processing platform, cause said processing platform to perform operations comprising:
transmitting a multicast poll to multiple electronic devices; and
receiving a response from each of the multiple electronic devices, each of the responses being received at different times.

24. The medium of claim 23, wherein the operation of receiving comprises an operation of receiving training responses from which to determine parameters for spatial division multiple access operation.

25. The medium of claim 23, wherein the operations further comprise operations to determine a poll group for the multicast poll, the poll group indicating identifying information on each of the multiple electronic devices.

26. The medium of claim 23, wherein the operations further comprise operations to transmit a timing indicator to a particular one of the multiple electronic devices, the timing indicator indicative of a time delay for the particular one to wait before transmitting a particular one of the responses.

27. A machine-readable medium that provides instructions, which when executed by a processing platform, cause said processing platform to perform operations comprising:
receiving a multicast poll containing a particular identifier; and
transmitting a response to the multicast poll after a particular time delay associated with the particular identifier.

28. The medium of claim 27, wherein the operation of transmitting comprises an operation of transmitting a response from which parameters for spatial division multiple access operation my be determined.

29. The method of claim 27, wherein the operation of receiving comprises an operation of:
receiving a timing indicator; and
determining the particular time delay from the timing indicator.
